(19) United States
(12) Patent Application Publication
(10) Pub. No.: US 2002/0176015 A1
(43) Pub. Date: Nov. 28, 2002

(54) Image capturing camera and projector device

(76) Inventor: Hans A. Lichtfuss, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/863,669

(22) Filed: May 23, 2001

(51) Int. Cl. H04N 5/222

(52) U.S. Cl. 348/333.1

(57) ABSTRACT

The present invention is directed to a system and method for displaying an image wherein the apparatus includes an image transducer for capturing image data from an incoherent wireless electromagnetic transmission, which transmission may be in the form of visible light, a memory for storing captured image data, and a projection system for projecting an image derived from stored captured image data onto a viewing surface separate from the apparatus and disposed so as to reflect the projected derived visible image. The transducer, memory, and projector are preferably confined within a single portable enclosure.

### RELATED APPLICATIONS

The present invention is related to commonly assigned, co-pending, concurrently filed U.S. patent application Ser. No. [Attorney Docket No. 10004915-1], entitled “INTERNET IMAGE PROJECTOR,” which is hereby incorporated herein by reference.

### TECHNICAL FIELD

The present invention relates in general to image capture and in particular to the combination of image capture, storage, and display capabilities in a single unit.

### BACKGROUND

When employing image capture devices, such as digital cameras, it is generally desirable to view captured images both in printed form and/or in electronic form, the latter being used on occasion as a predictor of the appearance of the quality of a printed image arising from the captured image. It is generally desirable to view images as conveniently as possible, with a minimum of expenditure of time and in a manner which minimizes the amount of additional required equipment.

Currently, users of such image capture equipment may print captured images by transferring captured digital images to a computer and printing the images. However, such an approach may be cumbersome, inconvenient, and wasteful of paper, where a user may have many images to review but only wishes to print a selection thereof. Moreover, the need for a printer may represent an additional expense if the user does not otherwise need one. Alternatively, a user may simply display a captured image on a computer screen after transferring a captured image into computer storage. Yet another alternative includes providing an image to a projector which in turn projects such image onto a viewing surface. Such projectors generally require substantial electric power and are generally powered with wired connections rather than portable energy supplies. Projectors may be adapted to receive image data via employing a video input.

The above approaches generally suffer from the limitation that they involve the use of equipment, such as computers, printers, and projectors which are generally not portable and which may not be available at the time and place where viewing of the captured images is sought. Accordingly, where a camera user wishes to review images “on-site” or in a location where photography is actually being conducted, the use of computer displays and computer printers generally do not present a useful image viewing alternative.

An alternative mechanism for reviewing captured image data involves the deployment of miniature displays, generally in the form of LCD (liquid crystal display) screens, on the cameras themselves for viewing of captured images. This approach is conducive for viewing images at sites where computer equipment is unavailable or inconvenient to use. Moreover, the images may be viewed without employing possibly cumbersome additional equipment. However, such screens are generally not suitable for viewing by more than one user at a time, thereby depriving a significant number of viewers of a sense of immediacy upon viewing the same image at the same time. In addition, such “on-camera” displays are quite small and generally present images with limited resolution. Accordingly, a user may not be provided with a helpful indication as to the quality of the captured image as it would appear on a larger electronic display and/or in printed form.

Accordingly, it is a problem in the art that computers and computer printers are cumbersome and unsuitable for many situations in which a camera user might wish to view captured images.

It is a further problem in the art that the use of computers, computer displays or monitors, printers, and/or projectors for viewing of captured images may represent a significant added expense for users who have not other use for such equipment.

It is a further problem in the art that miniature displays mounted on cameras are not suitable for simultaneous viewing by a large group of people.

It is a still further problem in the art that camera-mounted displays are generally quite small and may not provide a meaningful indication of the quality of the image being viewed when displayed by other means.

### SUMMARY OF THE INVENTION

The present invention is directed to a system and method for displaying an image wherein the apparatus includes an image transducer for capturing image data from an incoherent wireless electromagnetic transmission, which transmission may be in the form of visible light, a memory for storing captured image data, and a projection system for projecting an image derived from stored captured image data onto a viewing surface separate from the apparatus and disposed so as to reflect the projected derived visible image. The transducer, memory, and projector are preferably confined within a single portable enclosure.

### BRIEF DESCRIPTION OF THE DRAWING

FIG. 1 depicts a projecting camera able to project stored images according to a preferred embodiment of the present invention;

FIG. 2 depicts an apparatus for projecting stored images according to an alternative embodiment of the present invention; and

FIG. 3 depicts computer apparatus adaptable for use with a preferred embodiment of the present invention.

### DETAILED DESCRIPTION

The present invention is directed to a system and method which provides an ability to capture and store image data and subsequently display this stored image data on demand wherever and whenever a user wishes. Preferably, the inventive apparatus includes means for capturing, storing, and displaying images within a single, compact, and portable enclosure, thereby obviating a need for cumbersome and expensive external equipment for displaying images derived from stored image data. Herein, the terms “project” and “projection” generally correspond to a transmission of visible light.

In a preferred embodiment, a projection mechanism disposed within the inventive projecting camera provides a display of a stored image and operates to project this image through a suitably provided optical path in the camera for display on a viewing surface for convenient simultaneous viewing by a group of people. A user may select a surface for projection of an image based on the availability of suitable surfaces in a particular location. Although flat, reflective surfaces, such as a light colored wall, are preferred, nearly any surface may be used for viewing purposes.

In a preferred embodiment, the projecting camera employs an internal light source to aid in projecting an image out of the camera through substantially the same optical path through which images arrive for capture within the projecting camera. However, numerous variations of this embodiment may be practiced without departing from the inventive concept embodied herein. In this manner, the inventive camera provides a self-contained image capture, storage, and projection device generally able to display captured images anywhere, anytime, in a manner conveniently and simultaneously viewable by a group of persons of substantial number. The foregoing may preferably be effected without a need for any equipment other than the projecting camera itself.

While the above discussion has been directed primarily toward the use of digital still cameras, the inventive principle of the instant application may be applied to video cameras (both analog and digital) and to still images provided by analog video cameras, as well as to any image capture mechanism which stores image data on either solid state, or magnetic tape or other media, which is in a form readily and rapidly convertible to a viewable image.

Accordingly, it is an advantage of a preferred embodiment of the present invention that the projecting camera is able to conveniently display viewable images without the aid of cumbersome and expensive external equipment.

It is a further advantage of a preferred embodiment of the present invention that the projecting camera may display an image having a size and quality which enables one or more viewers to meaningfully evaluate the quality of the captured image without resorting to generating a hard copy printout or computer screen display of the image.

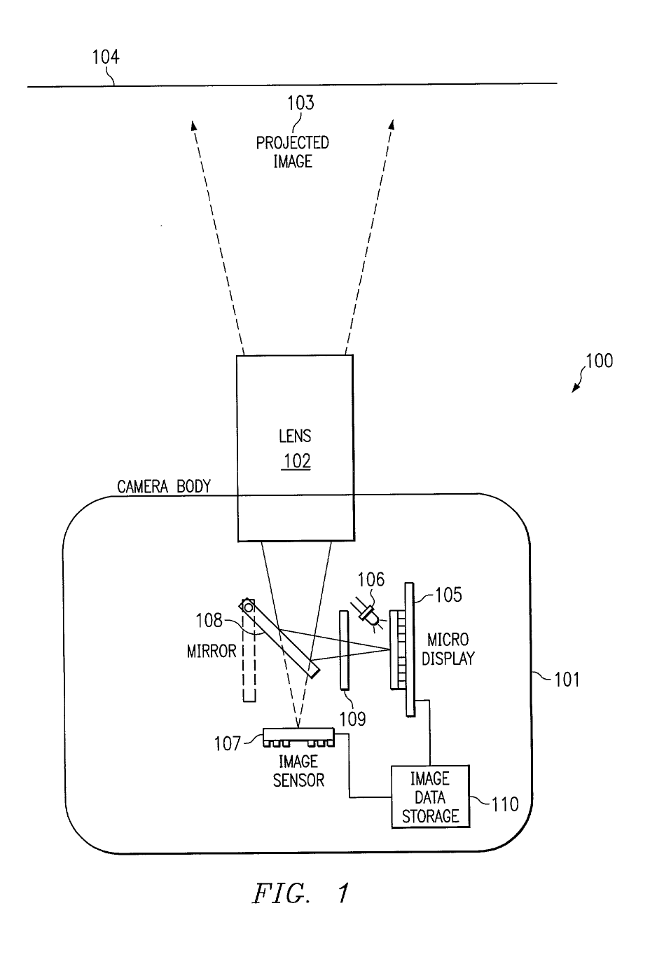

FIG. 1 depicts a camera able to project stored images according to a preferred embodiment of the present invention. When projecting camera 100 operates in an image capture mode, mirror or reflector 108 is preferably aligned with the direction of image flow between lens or lens assembly 102 (lens assembly 102 may include one lens or a plurality of lenses in cooperation with one another) and image sensor 107, which alignment is shown with dashed lines in FIG. 1, and located so as to avoid obstructing the image capture image flow path between lens assembly 102 and image sensor 107. When employing this (image capture) mode, image light travels into camera 100, through lens assembly 102, toward image sensor 107 for capture of image data representing the incoming image.

In a preferred embodiment, light energy from the incoming image is converted into digital data employing a method consistent with the type of device(s) used for image sensor 107, which method(s) are known in the art and will therefore not be discussed in detail herein. Image sensor 107 may be a CCD (Charge Coupled Device), CMOS (Complementary Metal Oxide Semiconductor) sensor or other device for transducing visible light into data stored in one of several formats allowing ready data retrieval, such formats including but not limited to analog tape, digital data on magnetic tape, solid state digital storage, computer hard drive, computer floppy drive, Smart Card, and RAM. Alternatively, data could be stored by communicating image data from the projecting camera (or other image capture device) via a wired or wireless connection to a remotely located storage site over a dedicated or publicly accessible network.

In a preferred embodiment, after an image is received at image sensor 107, it is preferably converted into digital data according to a process which is known in the art. The resulting digital data is preferably stored in image data storage 110. Image data storage 110 may employ solid state storage, ROM, RAM, magnetic tape, computer hard drive, Smart Card, floppy disk, or other volatile and/or non-volatile storage media. Image data storage 110 is preferably accessible to an intelligent control system which is able to select data associated with a specific stored image for retrieval and display purposes.

In a preferred embodiment, projecting camera 100 is able to operate in a projection mode in addition to an image capture mode. When in projection mode, camera 100 is preferably able to select a stored image from image data storage 110, present the image on micro display 105, and transmit this image along an image projection flow path toward viewing screen 104 which is preferably separate from projecting camera 100. Alternatively, viewing screen 104 could be mechanically connected to camera body 101.

In a preferred embodiment, when a user desires to use projecting camera 100 in projection mode, an appropriate command may be given to a camera control system to select images for projection from image data storage 110 and to adjust the image flow path for projection operation. When in projection mode, projecting camera 100 preferably operates to configure a projection image flow path leading from micro display 105 to reflector or mirror 108 through lens assembly 102 to thereby project image 103 onto viewing surface 104.

In a preferred embodiment, the following steps may be followed in order to properly transition from image capture operation or mode to image display or projection operation. The sequence identified in the following is but one preferred order in which the recited steps may be performed. It will be appreciated that numerous variations in the order of execution of the following steps may be practiced, and all such variations are included within the scope of the present invention. First, image sensor 107 is preferably disabled as incoming image light is not expected to be directed thereto during projection mode operation of projecting camera 100. Next, micro display 105 is preferably enabled and caused to display a user-selected image on a surface facing mirror 108, which surface is preferably integral to micro display 105. Next, light source 106 is preferably turned on to enable the image displayed on a surface of micro display 105 to travel along a projection image flow path toward viewing surface 104 with sufficient intensity to be readily visible to persons observing viewing screen 104. Optional micro display adjustment lens 109 may be moved or adjusted to properly adjust an image emerging from micro display 105. Furthermore, main lens assembly 102 may be adjusted to set the focus and/or size of projected image 103 on viewing surface 104.

In a preferred embodiment, the user would aim projecting camera 100 at a flat white or other lightly colored surface, when in projection mode, in order to achieve a preferred quality of projected image 103. However, where such preferred surfaces are not available, various less preferred surfaces may be substituted therefor. Viewing surface 104 need not be a specialized photographic display surface. Where circumstances warrant, a user may improvise as needed to provide an operational viewing surface. Effectively, any surface, whether natural or artificial, which reflects light may be employed. Thus, walls, bodies of water, snow, paper, windows, and an assortment of other surfaces may be beneficially employed in cooperation with the inventive projecting camera.

In a preferred embodiment, micro display 105 is a VGA (Video Graphics Adapter) silicon display providing a resolution of 640×480 pixels per inch. However, micro displays employing resolutions higher or lower than 640×480 may also be employed. Moreover, display technologies other than silicon displays may be employed. Micro display adjustment lens 109 may be included to enable adjustment of the image emerging from micro display 105 in addition to an amount of adjustment afforded by main lens assembly 102. However, in an alternative embodiment, adjustment lens 109 may be omitted and all adjustment provided by main lens assembly 102.

In a preferred embodiment, light source 106 is a high powered LED (light emitting diode) light source which includes red, green, and blue components for illuminating micro display 105 during projection mode operation of projecting camera 100. Alternatively, the LED source may be white or include one or more of any other color components. In yet other alternative embodiments, fluorescent and/or incandescent light sources may be employed, and all such variations are included within the scope of the present invention.

In the embodiment of FIG. 1, light source 106 is shown disposed inside camera body 101. The deployment of a light source within camera body 101 presents the advantage of providing a fully functional self-contained appliance. However, light source 106 may consume energy at a substantial rate and for substantial periods of time, thereby placing substantial demands on portable power supplies, such as, for instance, one or more batteries, disposed within projecting camera 100. In an alternative embodiment, light for projection purposes could be supplied from a source located outside camera 100 and fed into camera body 101 when needed. Camera 100 could be configured to accept light input from a standard commercially available light source such as a flashlight, or alternatively, may employ a customized light source specifically designed to accommodate projecting camera 100. In yet another alternative embodiment, light source 106 could be kept within camera body 101 and power supplied to camera 100 via a separate battery pack or wired power source in order to power light source 106 and thereby alleviate a burden on any batteries disposed within projecting camera 100.

In a preferred embodiment, mirror or reflector 108 is movable so as to allow projecting camera 100 to operate as an image capture device when the reflector 108 is aligned parallel to a path between lens assembly 102 and image sensor 107 (the main lens-image sensor path) to thereby provide an undisturbed image flow path therebetween, and to operate as a projector when reflector 108 is aligned at an angle to the main lens-image sensor path to thereby direct image light from micro display 105 through lens assembly 102 and out of projecting camera 100 toward viewing surface 104. In the embodiment of FIG. 1, changes in the image flow path of camera 100 may be accomplished, for example, by pivoting reflector 108 about a pin or shaft connecting reflector 108 to camera body 101. In an alternative embodiment, reflector 108 may be moved into and out of a projection mode position employing a range of geometric motion including translation into and out of a projection mode location and orientation and being rotated into position about any one of a number of possible axes.

In yet another alternative embodiment, reflector 108 could be kept in the position indicated by the solid lines depicting reflector 108 shown in FIG. 1 throughout both image capture mode operation as well as projection mode operation of camera 100. In this case, the optical characteristics of reflector 108 could be controllably modified in order to be effectively transparent and unobtrusive to incoming image light during image capture mode operation and to be reflective during projection mode operation so as to reflect image light from micro display 105 through lens assembly 102 and toward viewing surface 104. This embodiment of the present invention could be practiced in conjunction with liquid crystal which is appropriately stimulated by electrical energy in order provide for selective control of the translucency and/or reflectiveness of reflector 108.

In a preferred embodiment, the projection image flow path overlaps to as great an extent as possible with the image capture image flow path in order to optimally economize on precious space within projecting camera 100. This is the case in the embodiment of FIG. 1 where projected image 103 exits projecting camera 100 through the same lens assembly 102 through which incoming image light for image capture arrives when projecting camera 100 is operating in image capture mode. In an alternative embodiment however, substantially different or completely different paths could be employed for image capture and for image projection. Such an arrangement could be employed to devise and deploy optical path features optimized for image capture purposes along one physical path and for projection purposes in another. For the projection image flow path, such optical path features could include the geometric characteristics of orifices in the camera body 101 through which projected images pass, and the characteristics of lenses used to adjust the focus, size, and other attributes of projected image 103.

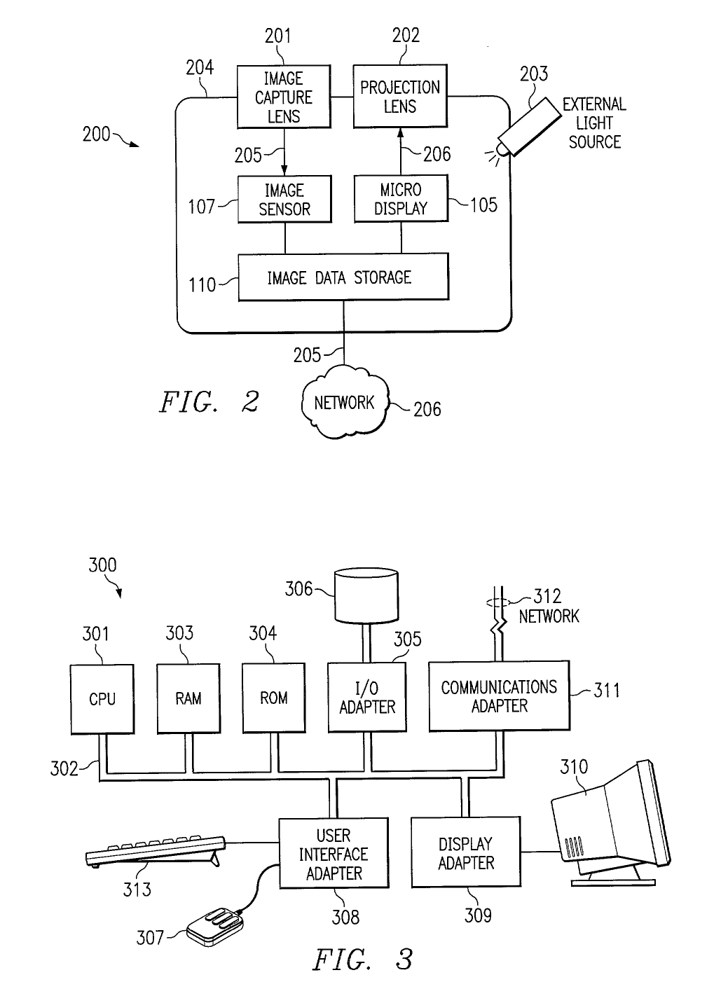

FIG. 2 depicts apparatus for projecting stored images according to an alternative embodiment of the present invention. In an alternative embodiment of the present invention, separate image flow paths for image capture and projection could be employed. Such separate image paths would generally obviate a need for a moving part, such as a moving reflector, for altering an image flow path when switching from one mode of projection camera 100 operation to another but would generally involve allocating more space in projection camera 200 to accommodate the deployment of separate lenses 201-202 and separate image flow paths 205-206.

In the alternative embodiment of FIG. 2, incoming image light would arrive at image capture lens 201 and proceed along image capture image flow path 205 toward image sensor 107 which preferably operates to capture image data from the incoming image and transfers the image data to image data storage 110. Data stored in image data storage 110 is preferably available for retrieval upon user request.

When using projecting camera 200 in projection mode, the user preferably requests retrieval of image data from image data storage 110 which causes an image synthesized from the retrieved image data to be displayed at micro display 105. External light source 203 is preferably illuminated to enable the image displayed on micro display 105 to be projected along projection image flow path 206 toward projection lens 202 and out of camera body 204.

Additionally or alternatively, image data may be acquired from network 206 employing network connection 205. Image data received from such a network could be stored in image data storage 110 and then communicated to micro display 105. Alternatively, image data from network connection 205 could be communicated directly to micro display 105, bypassing image data storage 110. Image data acquired from network 206 in this manner could then, of course, be transmitted along projection image flow path 206 onto a suitable projection surface, such as viewing surface 104. It will be appreciated that the display of image data received from a network connection 205 is not limited to being used in conjunction with the other aspects of the embodiment shown in FIG. 2, such as the use of separate capture and projection flow paths.

In the embodiment of FIG. 2, external light source 203 is preferably removably attachable to camera body 204. An arrangement involving a custom attachment between camera body 204 and external light source 203 which is specifically designed to accommodate mechanical attachment needs of camera body 204 as well as the illumination needs of image projection out of projecting camera 200. Alternatively, camera body 204 could be designed to receive a general purpose flashlight or other illumination device so long as the general purpose device has mechanical dimensions within a range which can be accommodated by camera body 204 and illumination power sufficient to drive the projection of a retrieved image along image flow path 206 toward a viewing surface.

In a preferred embodiment, deployment of a light source separable from projecting camera 200 relieves camera 200 of the burden of supplying electric power to an integrally provided light source, such as, for instance, light source 106 shown in FIG. 1. Moreover, the use of mechanically separate camera and light source would preferably enable a larger and more powerful light source to be used in conjunction with camera 200 than could be practically deployed in a manner integral with camera 200. Since external light source 203 is preferably powered by its own batteries or by a wired power connection, camera 200 would preferably also experience lower power requirements when used in cooperation with an external light source than when provided with an integral light source.

In a preferred embodiment, where external light source 203 is deployed as an alternative to an integrally mounted light source within camera 200, camera 200 could be used for image capture with light source 203 detached from camera 200, thereby allowing camera 200 to be as light, compact, and maneuverable as possible during image capture mode operation of camera 200. During periods when external light source 203 is not connected to camera 200, an appropriate cap or fitting may be located so as to plug an opening in camera body 204 into which light source 203 is attachable during projection mode operation of camera 200.

When a user is ready to display captured images, external light source 203 could be attached to camera 200 to provide illumination of display 105. Light source 203 could then preferably be readily removed from camera 200 upon completion of projection mode operation of camera 200.

FIG. 3 illustrates computer system 300 adaptable for use with a preferred embodiment of the present invention. Central processing unit (CPU) 301 is coupled to system bus 302. The CPU 301 may be any general purpose CPU, such as an Hewlett Packard PA-8200. However, the present invention is not restricted by the architecture of CPU 301 as long as CPU 301 supports the inventive operations as described herein. Bus 302 is coupled to random access memory (RAM) 303, which may be SRAM, DRAM, or SDRAM. ROM 304 is also coupled to bus 302, which may be PROM, EPROM, or EEPROM. RAM 303 and ROM 304 hold user and system data and programs as is well known in the art.

It will be appreciated that the inventive concepts disclosed herein are applicable to digital still cameras, digital camcorders, and analog video cameras. Moreover, any image capture device which stores images in a form such that the images are ready for viewing may benefit from the inventive concepts disclosed herein.

Bus 302 is also coupled to input/output (I/O) adapter 305, communications adapter card 311, user interface adapter 308, and display adapter 309. The I/O adapter 305 connects to storage devices 306, such as one or more of hard drive, CD drive, floppy disk drive, tape drive, to the computer system. Communications adapter 311 is adapted to couple the computer system 300 to a network 312, which may be one or more of local area network (LAN), wide-area network (WAN), Ethernet or Internet network. User interface adapter 308 couples user input devices, such as keyboard 313 and pointing device 307, to the computer system 300. The display adapter 309 is driven by CPU 301 to control the display on display device 310.

What is claimed is:

1. Apparatus for displaying an image, the apparatus comprising:
an image transducer for capturing image data received via an incoherent wireless electromagnetic transmission;
a memory for storing said captured image data; and
a projection system for projecting a visible image derived from said stored captured image data onto a viewing surface separate from said apparatus and disposed so as to reflect said projected derived visible image, wherein said transducer, said memory, and said projector are confined within a single portable enclosure.

2. The apparatus of claim 1 further comprising:
means for employing at least one lens assembly common to both an image capture image flow path and a projection image flow path.

3. The apparatus of claim 1 wherein said projection system comprises:
a display adjustment lens disposed between said projection system and at least one lens assembly.

4. The apparatus of claim 2 wherein said employing means comprises:
means for transmitting said derived visible image through said at least one common lens assembly during projection mode operation of said apparatus.

5. The apparatus of claim 4 wherein said transmitting means comprises:
means for reflecting said derived visible image toward said common lens assembly.

6. The apparatus of claim 1 wherein said projection system comprises:
a micro display for displaying said derived image.

7. The apparatus of claim 6 wherein said micro display is a silicon display.

8. The apparatus of claim 6 wherein said projection system further comprises:
a light source for illuminating said micro display.

9. The apparatus of claim 8 wherein said light source is disposed within said single portable enclosure.

10. The apparatus of claim 8 wherein said light source is removably attachable to said single portable enclosure.

11. The apparatus of claim 1 wherein said memory comprises:
digital data storage.

12. The apparatus of claim 1 wherein said memory is disposed on magnetic tape.

13. The apparatus of claim 1 further comprising:
means for accepting image data from a remote source.

14. A method for displaying a captured image, the method comprising the steps of:
receiving an image within an image capture device;
transducing said received image into image data; and
projecting transduced ones of said images, out of said image capture device onto a viewing surface.

15. The method of claim 14 further comprising the step of:
storing said transduced image data.

16. The method of claim 14 further comprising the step of:
illuminating said transduced images.

17. The method of claim 15 wherein said step of illuminating comprises the step of:
energizing a light source disposed within said image capture device.

18. The method of claim 15 wherein said step of illuminating comprises the step of:
releasably attaching an external light source to said image capture device.

19. The method of claim 14 wherein said step of projecting comprises the step of:
employing at least one same lens assembly for said transducing step and for said projecting step.

20. The method of claim 14 further comprising the step of:
projecting a substantially continuous stream of additional presented derived images onto said viewing surface.

21. The method of claim 14 further comprising the step of:
projecting images received from sources external to said image capture device.

22. An image processing device for acquiring and displaying images, the device comprising:
means for converting images received through a lens attached to said device into image data; and
means for projecting selected ones of said image data out of said image processing device.

23. The image processing device of claim 22 wherein said receiving means, said converting means, said storing means, said recreating means, and said projecting means are disposed within a single enclosure.

24. The image processing device of claim 22 further comprising:
means for storing image data.

25. The image processing device of claim 22 wherein said stored image data is image data received through said lens.

26. The image processing device of claim 22 wherein said stored image data is image data received from sources external to said device.

27. The image processing device of claim 22 wherein said projecting means includes said lens attached to said device.
